(19) United States
(12) Patent Application Publication
(10) Pub. No.: US 2026/0265644 A1
(43) Pub. Date: Sep. 10, 2026

(54) BIOSURFACTANTS ON AREA-MEASURED PLASTIC ARTICLES

(71) Applicant: Evonik Operations GmbH, Essen (DE)

(72) Inventors: Alexandra Trambitas, Alzenau (DE); Konrad Grygiel, Duesseldorf (DE)

(73) Assignee: Evonik Operations GmbH, Essen (DE)

(21) Appl. No.: 19/165,174

(22) PCT Filed: Mar. 11, 2024
(86) PCT No.: PCT/EP2024/056331

§ 371 Date: Sep. 15, 2025

(30) Foreign Application Priority Data
Mar. 16, 2023 (EP) 23162250.7

(51) Int. Cl. C11D 1/66; C11D 1/06

(52) U.S. Cl. CPC C11D 1/662; C11D 1/06; C11D 2111/18

(57) ABSTRACT

The invention relates to biosurfactants and their use on area-measured plastic articles, especially in the context of cleaning.

### FIELD OF THE INVENTION

The invention relates to biosurfactants and their use on area-measured plastic articles, especially in the context of cleaning.

### PRIOR ART

Plastics are a wide range of synthetic or semi-synthetic materials that use polymers as a main ingredient. Their plasticity makes it possible for plastics to be moulded, extruded or pressed into solid objects of various shapes.

Plastics in general are considered to be stable against many environmental influences and have a slow decomposition rate in nature.

However, plastics do suffer from surfactants, for example by prolonged exposure or repeated cleaning procedures while using surfactants. This phenomenon is called environmental stress cracking (ESC), compare for example Kawaguchi et al. in Polymer Engineering and Science, Volume43, Issue2, pages 419-430, Environmental stress cracking (ESC) of plastics caused by non-ionic surfactants.

To sustainably use plastic articles for an extended period of time it is thus desirable to prevent ESC of the articles.

It is an object of the invention to provide a method of treating plastics with a reduced impact on the stress exerted on the plastics.

### DESCRIPTION OF THE INVENTION

It was found that, surprisingly, that biosurfactants can solve the problem of the instant invention.

The present invention therefore provides a method for treating an area-measured plastic article while using biosurfactants.

An advantage of the present invention is that the liquid compositions used in the instant invention foam strongly, i.e. generate large foam volumes.

A further advantage of the present invention is that the liquid compositions used in the instant invention generate foams stable overtime.

A further advantage of the present invention is that the liquid compositions used in the instant invention have good initial foaming behaviour.

A further advantage of the present invention is that the liquid compositions used in the instant invention have good skin compatibility.

A further advantage of the present invention is that the liquid compositions used in the instant invention have good run-off behaviour.

A further advantage of the present invention is that the liquid compositions used in the instant invention have good drying behaviour.

A further advantage of the present invention is that the liquid compositions used in the instant invention also show an excellent foam-forming capacity in the presence of oil soiling.

Another advantage of the present invention is that strongly foaming formulations may be formulated, without the use of surfactants, which have been prepared with ethylene oxide.

A further advantage is the reduced necessity for microbial active preservatives.

A further advantage of the liquid compositions used in the instant invention is their low viscosity and therefore simple processability in any desired aqueous surface-active system.

A further advantage of the liquid compositions used in the instant invention is their very good solubilizing efficacy for essential oils at low usage levels.

A further advantage of the liquid compositions used in the instant invention is their mildness and good physiological compatibility.

A further advantage of the liquid compositions used in the instant invention is their good rinseability compared to other surface-active compositions.

A further advantage of the liquid compositions used in the instant invention is that they can be synthesized free from petrochemical-based raw materials.

A further advantage of the liquid compositions used in the instant invention is that they can be synthesized free from critical raw materials such as tropical oils.

A further advantage of the liquid compositions used in the instant invention is their outstanding microbiological stability.

A further advantage of the liquid compositions used in the instant invention is that a particularly good foam creaminess can be achieved.

Another advantage of the present invention is that the liquid compositions used in the instant invention can be rinsed off from a surface, preferably from fibres, that had been cleaned, very easily.

A further advantage is that the liquid compositions used in the instant invention support enzyme stability in terms of storage.

A further advantage is that the liquid compositions used in the instant invention support probiotics stability in terms of storage.

Another advantage of the present invention is that the liquid compositions used in the instant invention show especially good emulsification and dispersing properties.

Another advantage of the present invention is that liquid compositions used in the instant invention have a low aqua toxicity.

Another advantage of the present invention is that the liquid compositions used in the instant invention can be formulated as 100% biodegradable.

Another advantage is that the liquid compositions used in the instant invention can be diluted very easily with water without the necessity of excessive stirring.

One advantage of the present invention is that the liquid compositions used in the instant invention have a positive odour profile.

Another advantage of the present invention is that the liquid compositions used in the instant invention have an improved colour stability.

A further advantage is that the liquid compositions used in the instant invention have improved cleaning properties of surfaces, especially fatty stains

Another advantage is that the liquid compositions used in the instant invention have excellent foaming properties.

A further advantage is that the liquid compositions used in the instant invention is their reduced irritation for human skin.

Another advantage is the mildness and good physiological compatibility of the liquid compositions used in the instant invention, in particular characterized by a high value in the red blood cell (RBC) test.

A further advantage is the good skin feel during and after washing of the liquid compositions used in the instant invention.

Another advantage is that the liquid compositions used in the instant invention have an improved ability to dissolve oils and fats.

Another advantage is that the liquid compositions used in the instant invention are easier removed from the surface and consequently needs less water for the rinsing step

Another advantage is that the liquid compositions used in the instant invention give the benefit of having a streakless cleaning when used to clean glass, mirrors, windshields and other sensitive surfaces.

Another advantage is that the liquid compositions used in the instant invention can clean effectively even at lower temperatures

The present invention therefore provides a method for treating an area-measured plastic article comprising the steps of
A) providing a liquid composition comprising a biosurfactant and bringing said article in contact with said liquid composition, and optionally
B) removing at least partially said liquid composition comprising said biosurfactant from said article.

Within the context of the present invention, “biosurfactants” are understood as meaning all glycolipids produced by fermentation. The term “biosurfactant” also covers glycolipids that are chemically or enzymatically modified after fermentation, as long as structurally a glycolipid remains. Raw materials for producing the biosurfactants that can be used are carbohydrates, in particular sugars such as e.g. glucose and/or lipophilic carbon sources such as fats, oils, partial glycerides, fatty acids, fatty alcohols, long-chain saturated or unsaturated hydrocarbons.

In the context of the present invention, the terms “surfactant” is understood to mean organic substances having interface-active properties that have the ability to reduce the surface tension of water at 20° C. and at a concentration of 0.5% by weight based on the overall composition to below 45 mN/m. Surface tension is determined by the Du Nouy ring method at 20° C.

In the context of the present invention, the terms “liquid” is understood to be liquid at a temperature of 25° C. and a pressure of 1013 mbar.

Where average values are stated hereinbelow, then, unless stated otherwise, these are number-averaged average values.

Unless stated otherwise, percentages are data in percent by weight.

Wherever measurement values are stated hereinbelow, then, unless stated otherwise, these have been determined at a temperature of 25° C. and a pressure of 1013 mbar.

The method according to the invention preferably is a method for impregnating, serving and cleaning, especially cleaning, said plastic article.

Preferably the method according to the invention is a method for serving said plastic article in terms of reducing and/or preventing environmental stress cracking, preferably caused by at least one non-biosurfactant, and/or in terms of reducing signs of aging, preferably caused by at least one non-biosurfactant.

The article of the method of the instant invention is an area-measured article, not a textile or cloth.

The article of the method of the instant invention is preferably a hard surface article. The article preferably is selected from the group of tiles, shelves, boards, furniture, housings of pumps, pump wheels, bull's eyes of washing machines, cutlery baskets and holders of dishwashers, food processing installations, washing machines, dishwashers, car cleaning devices, car relevant surfaces, train relevant surfaces, laminates, ceramic coated articles and metals, steel, especially of stainless steel grades, aluminum alloys and enameled steel.

The method according to the instant invention preferably is characterized in that said plastic article comprises a polymer selected from the group of acrylics, especially methacrylate and methyl methacrylate, polyamides, polyesters, silicones and polyurethanes, polycarbonate, polyethylene, polypropylene, polystyrene, polyvinyl chloride and polyoxymethylene, preferably selected from the group of polycarbonate, polystyrene and methyl methacrylate, more preferably selected from the group of acrylonitrile butadiene styrene, polycarbonate and polymethyl methacrylate.

The method according to the instant invention preferably is characterized in that said biosurfactant is selected from rhamnolipids, sophorolipids, glucolipids, cellulose lipids, mannosylerythritol lipids and trehalose lipids, preferably rhamnolipids, sophorolipids and glucolipids, most preferably rhamnolipids.

Mixtures of different biosurfactants can be comprised in the liquid composition, of course.

The biosurfactants can be produced e.g. as in EP 0 499 434, U.S. Pat. No. 7,985,722, WO 03/006146, DE 19648439, DE 19600743, JP 01 304034, CN 1337439, JP 2006 274233, JP 2006 083238, JP 2006 070231, WO 03/002700, FR 2740779, DE 2939519, U.S. Pat. No. 7,556,654, FR 2855752, EP 1445302, JP 2008 062179 and JP 2007 181789 or the documents cited therein. Suitable biosurfactants can be acquired e.g. from Soliance, France.

Preferably, the method according to the instant invention preferably is characterized in that said biosurfactant is selected from rhamnolipids, in particular mono-, di- or polyrhamnolipids, glucolipids, in particular mono-, di- or polyglucolipids, and sophorolipids, in particular mono-, di- or polysophorolipids, preferably selected from rhamnolipids and glucolipids, most preferably rhamnolipids.

The term “rhamnolipids” in the context of the present invention preferably is understood to mean particularly compounds of the general formula (I) and salts thereof,

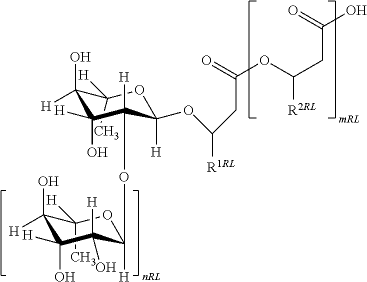

where
mRL=2, 1 or 0, preferably 1 or 0,
nRL=1 or 0,
R^{1RL} and R^{2RL}=mutually independently, identical or different, organic residues having 2 to 24, preferably 5 to 13 carbon atoms, in particular optionally branched, optionally substituted, particularly hydroxy-substituted, optionally unsaturated, in particular optionally mono-, bi- or triunsaturated alkyl residues, preferably those selected from the group consisting of pentenyl, heptenyl, nonenyl, undecenyl and tridecenyl and (CH₂)ₒ-CH₃ where o=1 to 23, preferably 4 to 12. If nRL=1, the glycosidic bond between the two rhamnose units is preferably in the α-configuration. The optically active carbon atoms of the fatty acids are preferably present as α-enantiomers (e.g. (R)-3-{(R)-3-[2-O-(α-L-rhamnopyranosyl)-α-L-rhamnopyranosyl]oxydecanoyl}oxydecanoate).

The term “di-rhamnolipid” in the context of the present invention is understood to mean compounds of the general formula (I) or salts thereof, where nRL=1.

The term “mono-rhamnolipid” in the context of the present invention is understood to mean compounds of the general formula (I) or salts thereof, where nRL=0.

Distinct rhamnolipids are abbreviated according to the following nomenclature:

“diRL-CXCY” are understood to mean di-rhamnolipids of the general formula (I), in which one of the residues R^{1RL} and R^{2RL}═(CH₂)ₒ-CH₃ where o=X-4 and the remaining residue R¹ or R²═(CH₂)ₒ-CH₃ where o═Y-4.

“monoRL-CXCY” are understood to mean mono-rhamnolipids of the general formula (I), in which one of the residues R^{1RL} and R^{2RL}=(CH₂)ₒ-CH₃ where o═X-4 and the remaining residue R^{1RL} or R^{2RL}=(CH₂)ₒ-CH₃ where o═Y-4.

The nomenclature used therefore does not distinguish between “CXCY” and “CYCX”.

For rhamnolipids where mRL=O, monoRL-CX or diRL-CX is used accordingly.

If one of the abovementioned indices X and/or Y is provided with “:Z”, this signifies that the respective residue R^{1RL} and/or R^{2RL} is equal to an unbranched, unsubstituted hydrocarbon residue having X-3 or Y-3 carbon atoms having Z double bonds.

Methods for preparing the relevant rhamnolipids are disclosed, for example, in EP2786743 and EP2787065.

Rhamnolipids applicable in the context of the instant invention can also be produced by fermentation of Pseudomonas, especially Pseudomonas aeruginosa, which are preferably non genetically modified cells, a technology already disclosed in the eighties, as documented e.g. in EP0282942 and DE4127908. Rhamnolipids produced in Pseudomonas aeruginosa cells which have been improved for higher rhamnolipid titres by genetical modification can also be used in the context of the instant invention; such cells have for example been disclosed by Lei et aL. in Biotechnol Lett. 2020 June;42(6):997-1002.

Rhamnolipids produced by Pseudomonas aeruginosa are commercially available from Jeneil Biotech Inc., e.g. under the tradename Zonix, from Logos Technologies (technology acquired by Stepan), e.g. under the tradename NatSurFact, from Biotensidion GmbH, e.g. under the tradename Rhapynal, from AGAE technologies, e.g. under the name R90, R95, R95Md, R95Dd, from Locus Bio-Energy Solutions and from Shanghai Yusheng Industry Co. Ltd., e.g. under the tradename Bio-201 Glycolipids.

The present invention provides a method preferably comprising in said liquid composition as said biosurfactant rhamnolipids, characterized in that the rhamnolipids comprise
51% by weight to 100% by weight, preferably 60% by weight to 95% by weight, particularly preferably 80% by weight to 90% by weight, of mono-rhamnolipids, especially those of formula (I) with nRL=0,
where the percentages by weight refer to the sum of all of the rhamnolipids comprised in the liquid composition.

The present invention provides a method alternatively preferably comprising in said liquid composition as said biosurfactant rhamnolipids, characterized in that the rhamnolipids comprise 71% by weight to 100% by weight, preferably 75% by weight to 95% by weight, particularly preferably 80% by weight to 90% by weight, of di-rhamnolipids, especially those of formula (I) with nRL=1,
where the percentages by weight refer to the sum of all of the rhamnolipids comprised in the liquid composition.

The present invention further provides a method preferably comprising in said liquid composition as said biosurfactant rhamnolipids, characterized in that the rhamnolipids comprise
56% by weight to 95% by weight, preferably 60% by weight to 80% by weight, particularly preferably 66% by weight to 70% by weight, of diRL-C10C10,
where the percentages by weight refer to the sum of all of the rhamnolipids comprised in the liquid composition.

A preferred method according to the invention is characterized in that the biosurfactant comprised in said liquid composition is said rhamnolipids as described above with a content of
0.5% by weight to 15% by weight, preferably 3% by weight to 12% by weight, particularly preferably 5% by weight to 10% by weight, of diRL-C10C12:1,
where the percentages by weight refer to the sum of all of the rhamnolipids comprised in the liquid composition.

A further preferred method according to the invention is characterized in that the biosurfactant comprised in said liquid composition is said rhamnolipids as described above with a content of 0.5 to 25% by weight, preferably 3% by weight to 15% by weight, particularly preferably 5% by weight to 12% by weight, of diRL-C10C12,
where the percentages by weight refer to the sum of all of the rhamnolipids comprised in the liquid composition.

A preferred method according to the invention is characterized in that the biosurfactant comprised in said liquid composition is said rhamnolipids as described above with a content of
0.1% by weight to 25% by weight, preferably 2% by weight to 10% by weight, particularly preferably 4% by weight to 8% by weight, of diRL-C8C10,
where the percentages by weight refer to the sum of all of the rhamnolipids comprised in the liquid composition.

An even further preferred method according to the invention is characterized in that the biosurfactant comprised in said liquid composition is said rhamnolipids as described above with a content of
0.1% by weight to 5% by weight, preferably 0.5% by weight to 3% by weight, particularly preferably
0.5% by weight to 2% by weight, of monoRL-C8C10 and/or, preferably and
0.1% by weight to 5% by weight, preferably 0.5% by weight to 3% by weight, particularly preferably
0.5% by weight to 2% by weight, of monoRL-C10C10,
where the percentages by weight refer to the sum of all of the rhamnolipids comprised in the liquid composition.

The present invention provides a method alternatively preferably comprising in said liquid composition as said biosurfactant rhamnolipids, characterized in that the rhamnolipids comprise 10% by weight to 30% by weight, preferably 20% by weight to 30% by weight, particularly preferably 25% by weight to 30% by weight, of monoRL-C10C10,
where the percentages by weight refer to the sum of all of the rhamnolipids comprised in the liquid composition.

The alternatively preferred method according to the invention is characterized in that the biosurfactant comprised in said liquid composition is said rhamnolipids as described above with a content of
10% by weight to 30% by weight, preferably 12% by weight to 25% by weight, particularly preferably 15% by weight to 20% by weight, of diRL-C10C10,
where the percentages by weight refer to the sum of all of the rhamnolipids comprised in the liquid composition.

The alternatively preferred method according to the invention is characterized in that the biosurfactant comprised in said liquid composition is said rhamnolipids as described above with a content of
10% by weight to 30% by weight, preferably 12% by weight to 25% by weight, particularly preferably 15% by weight to 20% by weight, of monoRL-C8C10,
where the percentages by weight refer to the sum of all of the rhamnolipids comprised in the liquid composition.

The alternatively preferred method according to the invention is characterized in that the biosurfactant comprised in said liquid composition is said rhamnolipids as described above with a content of
3% by weight to 25% by weight, preferably 5% by weight to 20% by weight, particularly preferably 10% by weight to 15% by weight, of monoRL-C10C12:1,
where the percentages by weight refer to the sum of all of the rhamnolipids comprised in the liquid composition.

The alternatively preferred method according to the invention is characterized in that the biosurfactant comprised in said liquid composition is said rhamnolipids as described above with a content of
1% by weight to 15% by weight, preferably 2% by weight to 10% by weight, particularly preferably 3% by weight to 8% by weight, of diRL-C10C12,
where the percentages by weight refer to the sum of all of the rhamnolipids comprised in the liquid composition.

Methods for preparing the relevant rhamnolipids are disclosed, for example, in EP2786743 and EP2787065.

Rhamnolipids applicable in the context of the instant invention can also be produced by fermentation of Pseudomonas, especially Pseudomonas aeruginosa, which are preferably non genetically modified cells, a technology already disclosed in the eighties, as documented e.g. in EP0282942 and DE4127908. Rhamnolipids produced in Pseudomonas aeruginosa cells which have been improved for higher rhamnolipid titres by genetical modification can also be used in the context of the instant invention; such cells have for example been disclosed by Lei et aL. in Biotechnol Lett. 2020 June;42(6):997-1002.

Rhamnolipids produced by Pseudomonas aeruginosa are commercially available from Jeneil Biotech Inc., e.g. under the tradename Zonix,from Logos Technologies (technology acquired by Stepan), e.g. under the tradename NatSurFact, from Biotensidion GmbH, e.g. under the tradename Rhapynal, from AGAE technologies, e.g. under the name R90, R95, R95Md, R95Dd, from Locus Bio-Energy Solutions and from Shanghai Yusheng Industry Co. Ltd., e.g. under the tradename Bio-201 Glycolipids.

In the context of the present invention, the term “sophorolipids” preferably is understood as meaning compounds of the general formulae (Ila) and (IIb) and salts thereof

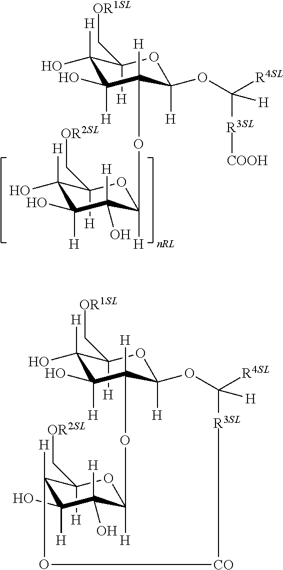

where
R^{1SL}═H or CO—CH₃,
R^{2SL}═H or CO—CH₃,
R^{3SL}=a divalent organic moiety which comprises 6 to 32 carbon atoms and which is unsubstituted or substituted by hydroxyl functions, is unbranched and optionally comprises one to three double or triple bonds,
R^{4SL}═H, CH₃ or a monovalent organic radical which comprises 2 to 10 carbon atoms and which is unsubstituted or substituted by hydroxyl functions, which is unbranched and which optionally comprises one to three double or triple bonds, and
nSL=1 or 0.

Sophorolipids may be used in accordance with the invention in their acid form or their lactone form. Preferred compositions according to the instant invention comprise a sophorolipid in which the ratio by weight of lactone form to acid form is in the range of 20:80 to 80:20, especially preferably in the ranges of 30:70 to 40:60.

To determine the content of sophorolipids in the acid or lactone form in a formulation, refer to EP1411111B1, page 8, paragraph [0053].

In connection with the present invention, the term “glucolipids” preferably is understood as meaning compounds of the general formula (III) and salts thereof,

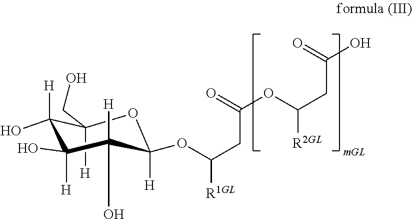

where
mGL=3, 2, 1 or 0, preferably 1 or 0,
R^{1GL} and R^{2GL}=independently of one another identical or different organic radical having 2 to 24 carbon atoms, in particular optionally branched, optionally substituted, in particular hydroxy-substituted, optionally unsaturated, in particular optionally mono-, di- or triunsaturated, alkyl radical, preferably one selected from the group consisting of pentenyl, heptenyl, nonenyl, undecenyl and tridecenyl and (CH₂)ₒ-CH₃ where o═1 to 23, preferably 4 to 12.

Distinct glucolipids are abbreviated according to the following nomenclature:

“GL-CXCY” is understood as meaning glucolipids of the general formula (III) in which one of the radicals R^{1GL} and R^{2GL}=(CH₂)ₒ-CH₃ where o═X-4 and the remaining radical R^{1GL} or R^{2GL}=(CH₂)ₒ-CH₃ where o═Y-4.

The nomenclature used thus does not differentiate between “CXCY” and “CYCX”.

If one of the aforementioned indices X and/or Y is provided with “:Z”, then this means that the respective radical R^{1GL} and/or R^{2GL}=an unbranched, unsubstituted hydrocarbon radical with X-3 or Y-3 carbon atoms having Z double bonds.

Methods for production of glucolipids can be carried out as described in WO2019154970.

A preferred method according to the instant invention is characterized in that said liquid composition provided in step A) comprises a non-biosurfactant, preferably selected from the group of anionic, cationic, non-ionic, semi-polar, amphoteric and zwitterionic surfactants, especially non-ionic surfactants, more preferably selected from the group of fatty alcohol alkoxylates and alkyl polyglucosides, especially fatty alcohol ethoxylates.

It is obvious, that a non-biosurfactant is different from a biosurfactant as defined in the context of the instant invention.

Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

Non-limiting examples of cationic surfactants include alklydimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, and combinations thereof.

Non-limiting examples of non-ionic surfactants include fatty alcohol ethoxylates (AE or AEO), which are preferably comprised in said liquid composition of the instant invention, alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), polyglycerol esters, glycerol esters, propoxylated fatty acid monoethanolamides (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

Non-limiting examples of amphoteric and zwitterionic surfactants include betaine, alkyldimethylbetaine, sulfobetaine, hydroxysultaine and combinations thereof.

Furthermore, bio-based surfactants can be included in said liquid composition of the instant invention, which are not based on glycolipids, for example lipopeptides like surfactins or phospholipids like lecithins.

A preferred method according to the instant invention is characterized in that said liquid composition provided in step A) comprises the biosurfactant in an amount of 0.1 wt.-% to 30 wt.-%, preferably 0.5 wt.-% to 10 wt.-%, more preferably 1.0 wt.-% to 8 wt.-%, where the percentages by weight refer to the total liquid composition.

When determining the content of biosurfactant in the context of the present invention, the mass of the non-salt form is taken into account; thus, the weight of the corresponding cation is disregarded.

A preferred method according to the instant invention is characterized in that said liquid composition provided in step A) comprises water in an amount of 70 wt.-% to 99.9 wt.-%, preferably 90 wt.-% to 99.5 wt.-%, more preferably 92 wt.-% to 99.0 wt.-%, where the percentages by weight refer to the total liquid composition.

A preferred method according to the instant invention is characterized in that said liquid composition provided in step A) comprises the non-biosurfactant in an amount of 0.1 wt.-% to 30 wt.-%, preferably 0.5 wt.-% to 10 wt.-%, more preferably 1.0 wt.-% to 8 wt.-%, where the percentages by weight refer to the total liquid composition.

A preferred method according to the instant invention is characterized in that said liquid composition provided in step A) comprises the biosurfactant in an amount of 20 wt.-% to 100 wt.-%, preferably 30 wt.-% to 70 wt.-%, more preferably 40 wt.-% to 60 wt.-%, where the percentages by weight refer to the sum of all surfactants comprised in the liquid composition.

In step B) of the method of the instant invention said liquid composition comprising said biosurfactant is removed at least partially from.

Said removing is preferably by draining said liquid composition and rinsing said article, preferably with water.

The instant invention further provides the use of a biosurfactant to reduce and/or prevent environmental stress cracking, preferably caused by at least one non-biosurfactant, of an area-measured plastic article.

The instant invention further provides the use of a biosurfactant to reduce signs of aging, preferably caused by at least one non-biosurfactant, of an area-measured plastic article. Signs of aging preferably are selected from the group of scratches, dull surface, uneven gloss and cracked surface.

Preferably the uses according to the instant invention are characterized in that said biosurfactant is selected from the group of rhamnolipids, glucolipids and sophorolipids, preferably rhamnolipids and glucolipids, most preferably rhamnolipids.

Preferably the uses according to the instant invention are characterized in that said non-biosurfactant causing the environmental stress cracking and/or signs of aging is selected from the group of anionic, cationic, non-ionic, semi-polar, amphoteric and zwitterionic surfactants, especially non-ionic surfactants, more preferably selected from the group of fatty alcohol alkoxylates and alkyl polyglucosides, especially fatty alcohol ethoxylates.

Preferably the uses according to the instant invention are characterized in that said biosurfactant is comprised in a liquid composition together with said non-biosurfactant.

In the uses according to the instant invention the same preferred embodiments in terms of article, biosurfactant, non-biosurfactant, concentrations and polymers apply as outlined above for the method according to the instant invention.

The examples adduced hereinafter describe the present invention by way of example, without any intention that the invention, the scope of application of which is apparent from the entirety of the description and the claims, be restricted to the embodiments specified in the examples.

### EXAMPLES

### Example 1

This example demonstrates compatibility of biosurfactants with plastic materials by examining extent of environmental stress cracking induced on variety of plastics by surfactant solutions.

The evaluation of material care was conducted according to the internal test methodology, which was adapted from the recommendation of German Cosmetic, Toiletry, Perfumery and Detergent Association (IKW): “IKW Recommendation for the Quality Assessment of the Product Performance of All-Purpose Cleaners 2014” (IKW Test Protocol). The principle of the test was to assess environmental stress cracking of selected plastic materials induced by an exposure to aqueous solutions of surfactants. For the tests, four different types of test sticks were used, that were made of acrylonitrile-butadiene-styrene copolymer, polystyrene, polycarbonate, and poly(methyl methacrylate), respectively. A hole was drilled through each of the test sticks (drill 2.7 and reamer 2.9 H7) and a non-rusting steel pin (dowel pin DIN 6325 Tol.: m6 3×10) was pressed vertically into each of the test sticks using a device e.g. rack and pinion press type 5. Subsequently, the test sticks were dipped for 30 seconds in test solutions (Table 1). After removing the sticks from the solution, adhering liquid was not removed and the sticks were placed horizontally at room temperature. The process of dipping sticks in test solution was repeated every 24 hours, five days a week (Monday to Friday), for the period of two weeks. The appearance of test sticks was assessed every 24 hours for occurrence of stress cracks and documented. The following plastics were tested: Acrylonitrile butadiene styrene —ABS Galvano Novodur, Polycarbonate—Makrolon, Polymethyl methacrylate—Plexiglas 8N, and Polystyrene.

Formulations described in the Table 1 have been prepared according to the following protocol. Initially, a measured amount of water was introduced into a glass beaker of a suitable size. Subsequently, required amount of surfactant were added at room temperature and under vigorous stirring. Finally, any remaining amount of water was introduced to ensure desired concentration of surfactants. All ingredients were mixed using a magnetic stirrer for 5 minutes to ensure a homogenous solution. The exemplary compositions were easily pourable and stable at room temperature for extended period.

Rhamnolipids were prepared as described in example 1 of EP3023431.

The sophorolipid used is a sophorolipid REWOFERMS SL ONE from Evonik, which has a lactone to acid ratio of 40:60.

TABLE 1
Compositions of Test formulation 1 and 2, as well as Benchmark formulations
1, 2, and 3 used in environmental stress cracking test.

| | Test | Test | Benchmark | Benchmark | Benchmark |
|---|---|---|---|---|---|
| | formulation | formulation | formulation | formulation | formulation |
| | 1/% | 2/% | 1/% | 2/% | 3/% |
| Rhamnolipids | 5.0 | 0.0 | 0.0 | 0.0 | 0.0 |
| Sophorolipids | 0.0 | 5.0 | 0.0 | 0.0 | 0.0 |
| Linear alkyl | 0.0 | 0.0 | 5.0 | 0.0 | 0.0 |
| benzene | | | | | |
| sulfonate, | | | | | |
| sodium salt | | | | | |
| C12-14 fatty | 0.0 | 0.0 | 0.0 | 5.0 | 0.0 |
| alcohol | | | | | |
| ethoxylate, 6 EO | | | | | |
| Alkyl | 0.0 | 0.0 | 0.0 | 0.0 | 5.0 |
| polyglucoside | | | | | |
| Water | Add to 100% | Add to 100% | Add to 100% | Add to 100% | Add to 100% |

The results of environmental stress cracking are summarized in Table 2. Surprisingly, no stress cracking was observed in polymethyl methacrylate, polycarbonate, acrylonitrile butadiene styrene, nor polystyrene sticks upon exposure to Test formulation 1 and Test formulation 2.

Exposure to Benchmark formulation 1 induced environmental stress cracking in polycarbonate and acrylonitrile butadiene styrene, while no cracks were observed in polymethyl methacrylate nor polystyrene. Benchmark formulation 2 induced environmental stress cracking in all tested plastic materials while Benchmark formulation 3 led to environmental stress cracking in polycarbonate samples. No cracks were observed in polymethyl methacrylate, acrylonitrile butadiene styrene, nor polystyrene samples upon exposure to Benchmark formulation 3. Therefore, it was unexpectedly found that Test formulations 1 and 2 are mild to plastic materials as they do not cause environmental stress cracking of common plastics such as polymethyl methacrylate, polycarbonate, acrylonitrile butadiene styrene, nor polystyrene under the test conditions.

TABLE 2
Results of environmental stress cracking after 14 days (Yes—stress cracking observed
after test completion, No—No stress cracking observed after test completion)

| | Test | Test | Benchmark | Benchmark | Benchmark |
|---|---|---|---|---|---|
| | formulation | formulation | formulation | formulation | formulation |
| | 1 | 2 | 1 | 2 | 3 |
| Polymethyl | No | No | No | Yes | No |
| methacrylate | | | | | |
| Polycarbonate | No | No | Yes | Yes | Yes |
| Acrylonitrile | No | No | Yes | Yes | No |
| butadiene | | | | | |
| styrene | | | | | |
| Polystyrene | No | No | No | Yes | No |

### Example 2

This example demonstrates the effect of mixtures of biosurfactants and legacy surfactants by examining extent of environmental stress cracking induced on variety of plastics by surfactant solutions.

The evaluation of material care was conducted according to the internal test methodology, which was adapted from the recommendation of German Cosmetic, Toiletry, Perfumery and Detergent Association (IKW): “IKW Recommendation for the Quality Assessment of the Product Performance of All-Purpose Cleaners 2014” (IKW Test Protocol). The principle of the test was to assess environmental stress cracking of selected plastic materials induced by exposure to aqueous solutions of surfactants. For the tests, four different types of test sticks were used, that were made of acrylonitrile-butadiene-styrene copolymer, polystyrene, polycarbonate, and poly(methyl methacrylate), respectively. A hole was drilled through each of the test sticks (drill 2.7 and reamer 2.9 H7) and a non-rusting steel pin (dowel pin DIN 6325 Tol.: m6 3×10) was pressed vertically into each of the test sticks using a device e.g. rack and pinion press type 5. Subsequently, the test sticks were dipped for 30 seconds in test solutions (Table 1). After removing the sticks from the solution, adhering liquid was not removed and the sticks were placed horizontally at room temperature. The process of dipping sticks in test solution was repeated every 24 hours, five days a week (Monday to Friday), for the period of two weeks. The appearance of test sticks was assessed every 24 hours for occurrence of stress cracks and documented. The following plastics were tested: Acrylonitrile butadiene styrene —ABS Galvano Novodur, Polycarbonate—Makrolon, Polymethyl methacrylate—Plexiglas 8N, and Polystyrene.

Formulations described in the Table 3 and 4 have been prepared according to the following protocol. Initially, a measured amount of water was introduced into a glass beaker of a suitable size. Subsequently, required amount of surfactant were added at room temperature and under vigorous stirring. Finally, any remaining amount of water was introduced to ensure desired concentration of surfactants. All ingredients were mixed using a magnetic stirrer for 5 minutes to ensure a homogenous solution. The exemplary compositions were easily pourable and stable at room temperature for extended period.

TABLE 3
Compositions of Test formulations 3 and 4 as well as Benchmark
formulation 4 used in environmental stress cracking test.

| | Test | Test | Benchmark |
|---|---|---|---|
| | formulation | formulation | formulation |
| | 3/% | 4/% | 4/% |
| Rhamnolipids | 2.5 | 0.0 | 0.0 |
| Sophorolipids | 0.0 | 5.0 | 0.0 |
| C12-14 fatty | 2.5 | 2.5 | 2.5 |
| alcohol | | | |
| ethoxylate, 6 | | | |
| EO | | | |
| Water | Add to 100% | Add to 100% | Add to 100% |

TABLE 4
Compositions of Test formulations 5 to 8 as well as Benchmark
formulations 5 and 6 used in environmental stress cracking test

| | Test | Test | Test | Test | Benchmark | Benchmark |
|---|---|---|---|---|---|---|
| | formulation | formulation | formulation | formulation | formulation | formulation |
| | 5/% | 6/% | 7/% | 8/% | 5/% | 6/% |
| Rhamnolipids | 2.5 | 2.5 | 0 | 0 | 0 | 0 |
| Sophorolipids | 0 | 0 | 5 | 5 | 0 | 0 |
| Linear alkyl | 2.5 | 0 | 2.5 | 0 | 2.5 | 0 |
| benzene | | | | | | |
| sulfonate, | | | | | | |
| sodium salt | | | | | | |
| Alkyl | 0 | 2.5 | 0 | 2.5 | 0 | 2.5 |
| polyglucoside | | | | | | |
| Water | Add to | Add to | Add to | Add to | Add to | Add to |
| | 100% | 100% | 100% | 100% | 100% | 100% |

The results of environmental stress cracking are summarized in Table 5. Benchmark formulation 4 containing 2.5% wt. of fatty alcohol ethoxylate led to environmental stress cracking of sticks made from all tested materials, so polymethyl methacrylate, polycarbonate, acrylonitrile butadiene styrene, and polystyrene. Surprisingly, sticks exposed to Test formulation 3 did not show any damage due to the environmental stress cracking after 14 days of test. This result was highly surprising, as Test formulation 3 contained the same amount of fatty alcohol ethoxylate as Benchmark formulation 4, containing additionally 2.5 wt %. of rhamnolipids. Thus, it becomes evident that addition of rhamnolipids to formulation containing surfactant such as fatty alcohol ethoxylate can hinder stress cracking effect that alcohol ethoxylates typically impose on plastic materials.

No environmental stress cracking was observed in plastic sticks exposed to Test formulation 4. Same experiments were done with Test formulations 5-8 and Benchmark Formulation 5 and 6 and the results are summarised in Table 6. It can be seen that in the case of the sticks exposed to Test Formulation 5-8 containing combination of Rhamnolipids or Sophorolipids and Linear alkyl benzene sulfonate, sodium salt and Alkyl polyglucoside did not show any damage due to the environmental stress cracking after 14 days of test. This was not the case for the formulations containing just the Linear alkyl benzene sulfonate, sodium salt or the Alkyl poly glycoside on the polycarbonate type of stick and on acrylonitrile butadiene styrene for the formulation containing just the Linear alkyl benzene sulfonate, sodium salt.

TABLE 5
Results of environmental stress cracking after 14 days
(Yes—stress cracking observed after test completion,
No—No stress cracking observed after test completion)

| | Test | Test | Benchmark |
|---|---|---|---|
| | formulation 3 | formulation 4 | formulation 4 |
| Polymethyl | No | No | Yes |
| methacrylate | | | |
| Polycarbonate | No | No | Yes |
| Acrylonitrile | No | No | Yes |
| butadiene | | | |
| styrene | | | |
| Polystyrene | No | No | Yes |

TABLE 6
Results of environmental stress cracking after 14 days (Yes—stress cracking observed
after test completion, No—No stress cracking observed after test completion)

| | Test | Test | Test | Test | Benchmark | Benchmark |
|---|---|---|---|---|---|---|
| | formulation | formulation | formulation | formulation | formulation | formulation |
| | 5 | 6 | 7 | 8 | 5 | 6 |
| Polymethyl | No | No | No | No | No | No |
| methacrylate | | | | | | |
| Polycarbonate | No | No | No | No | Yes | Yes |
| Acrylonitrile | No | No | No | No | Yes | No |
| butadiene | | | | | | |
| styrene | | | | | | |
| Polystyrene | No | No | No | No | No | No |

As is readily evident from the results, biosurfactants such as rhamnolipids and sophorolipids are surprisingly especially mild to plastic surfaces as they do not lead to environmental stress cracking of plastic materials such as polymethyl methacrylate, polycarbonate, acrylonitrile butadiene styrene, and polystyrene. Moreover, it becomes apparent that biosurfactants can be effectively used in combination with other common surfactants such as fatty alcohol ethoxylates to hinder environmental stress cracking caused by aqueous solutions of surfactants on plastics.

1. A method of treating an area-measured plastic article, the method comprising:
A) providing a liquid composition comprising a biosurfactant and bringing said article in contact with said liquid composition, and optionally
B) removing at least partially said liquid composition comprising said biosurfactant from said article.

2. The method according to claim 1, wherein said plastic article comprises a polymer selected from the group of acrylics, polyamides, polyesters, silicones and polyurethanes, polycarbonate, polyethylene, polypropylene, polystyrene, polyvinyl chloride and polyoxymethylene.

3. The method according to claim 1, wherein said biosurfactant is selected from the group of rhamnolipids, glucolipids and sophorolipids.

4. The method according to claim 1, wherein said liquid composition provided in A) comprises a non-biosurfactant.

5. The method according to claim 1, wherein said liquid composition provided in A) comprises the biosurfactant in an amount of 0.1 wt.-% where percentages by weight refer to a total liquid composition.

6. The method according to claim 1, wherein said liquid composition provided in A) comprises water in an amount of 70 wt.-% to 99.9 wt.-%, where the percentages by weight refer to the total liquid composition.

7. The method according to claim 4, wherein said liquid composition provided in A) comprises the non-biosurfactant in an amount of 0.1 wt.-% to 30 wt.-% where the percentages by weight refer to the total liquid composition.

8. The method according to claim 1, wherein said liquid composition provided in A) comprises the biosurfactant in an amount of 20 wt.-% to 100 wt.-% where the percentages by weight refer to a sum of all surfactants comprised in the liquid composition.

9. A method, comprising:
reducing of environmental stress cracking of an area-measured plastic article with a biosurfactant, and/or
preventing of environmental stress cracking of an area-measured plastic article with a biosurfactant.

10. A method, comprising:
reducing signs of aging, of an area-measured plastic article with a biosurfactant.

11. The method according to claim 9, wherein said biosurfactant is selected from the group of rhamnolipids, glucolipids and sophorolipids.

12. The method Use according to claim 9, wherein said plastic article comprises a polymer selected from the group of acrylics, polyamides, polyesters, silicones and polyurethanes, polycarbonate, polyethylene, polypropylene, polystyrene, polyvinyl chloride and polyoxymethylene.

13. The method according to claim 9, wherein the environmental stress cracking is caused by at least one non-biosurfactant, and wherein the at least one non-biosurfactant is selected from the group of anionic, cationic, non-ionic, semi-polar, amphoteric and zwitterionic surfactants.

14. The method according to claim 13, wherein said biosurfactant is comprised in a liquid composition together with said non-biosurfactant.
